(19) United States
(12) Patent Application Publication
(10) Pub. No.: US 2013/0059243 A1
(43) Pub. Date: Mar. 7, 2013

(54) PHOTORECEPTOR, COATING LIQUID FOR FORMING OUTERMOST LAYER OF PHOTORECEPTOR, AND IMAGE FORMING METHOD AND APPARATUS, AND PROCESS CARTRIDGE USING THE PHOTORECEPTOR

(71) Applicants: Mitsuaki HIROSE, Shizuoka (JP); Hideo NAKAMORI, Shizuoka (JP); Noboru TORIU, Shizuoka (JP); Keisuke SHIMOYAMA, Shizuoka (JP); Tomoharu ASANO, Shizuoka (JP)

(72) Inventors: Mitsuaki HIROSE, Shizuoka (JP); Hideo NAKAMORI, Shizuoka (JP); Noboru TORIU, Shizuoka (JP); Keisuke SHIMOYAMA, Shizuoka (JP); Tomoharu ASANO, Shizuoka (JP)

(21) Appl. No.: 13/597,945

(22) Filed: Aug. 29, 2012

(30) Foreign Application Priority Data
Sep. 2, 2011 (JP) 2011-191280

(51) Int. Cl. G03G 15/00

(52) U.S. Cl. 430/56; 399/159

(57) ABSTRACT

An electrophotographic photoreceptor including an electroconductive substrate; a photosensitive layer located overlying the electroconductive substrate; and an outermost layer located overlying the photosensitive layer, wherein the outermost layer includes filler and a crosslinked resin having a residual group of a polycarboxylic acid compound and a group having the following formula (1):

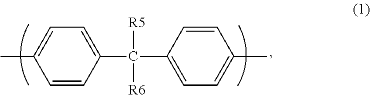

wherein each of R5 and R6 independently represents a hydrogen atom, or a substituted or unsubstituted alkyl group having 1 to 3 carbon atoms.

### CROSS-REFERENCE TO RELATED APPLICATIONS

This patent application is based on and claims priority pursuant to 35 U.S.C. §119 to Japanese Patent Application No. 2011-191280 filed on Sep. 2, 2011 in the Japan Patent Office, the entire disclosure of which is hereby incorporated herein by reference.

### FIELD OF THE INVENTION

The present invention relates to an electrophotographic photoreceptor. In addition, the present invention also relates to a coating liquid for forming an outermost layer of an electrophotographic photoreceptor, and to an image forming method, an image forming apparatus, and a process cartridge, which use the electrophotographic photoreceptor.

### BACKGROUND OF THE INVENTION

Recent electrophotographic image forming apparatuses such as laser printers, and digital copiers can stably produce high quality images, and therefore such image forming apparatuses have been broadly used.

Image bearing members used for such image forming apparatuses have a function of forming an electrostatic latent image on a surface thereof by being subjected to charging and irradiating, followed by forming a visible image by being subjected to developing in which the electrostatic latent image is developed by a developer. Electrophotographic photoreceptors are typically used as image bearing members. Hereinafter, image bearing members are sometimes referred to as electrophotographic photoreceptors or photoreceptors.

Organic photoreceptors have been typically used for electrophotographic photoreceptors because of having advantages in terms of costs, productivity, flexibility in material selection in designing, and environmental protection.

Recently, since a need exists for compact image forming apparatuses and therefore image forming apparatuses have been miniaturized, the photoreceptors used for such image forming apparatuses have also been miniaturized. In addition, since a need exists for maintenance-free image forming apparatuses capable of performing high speed image formation, there is a need for photoreceptors having high durability.

Further, in order to produce high quality images, toner having a small particle diameter has been used. When such small toner is used, a cleaning blade having a high hardness is contacted with a surface of a photoreceptor at a high pressure to satisfactorily remove such small toner particles from the surface of the photoreceptor, thereby easily abrading the surface of the photoreceptor.

Therefore, in order to impart high durability to an organic photoreceptor, it is essential to reduce the abrasion loss of the surface of the photoreceptor. In attempting to improve the abrasion resistance of a photoreceptor, there are proposals such that a particulate inorganic material is included in the outermost layer of a photoreceptor; and a crosslinked layer is formed as the outermost layer of a photoreceptor.

Specifically, an electrophotographic photoreceptor is proposed in which a particulate electroconductive metal oxide is included in the protective layer constituted of a crosslinked resin to control the resistance of the protective layer. It is described therein that the durability of the photoreceptor is improved by the protective layer.

However, it is described in JP2004-302450A that a photoreceptor having a protective layer in which an inorganic filler is dispersed has high abrasion resistance, but such a photoreceptor has high residual potential due to charge traps formed on the surface of the inorganic filler, thereby decreasing the image density. In addition, it is described therein that when the surface of the photoreceptor is roughened by the inorganic filler, the cleaning operation cannot be satisfactorily performed, thereby causing a toner filming problem in that a toner film is formed on the surface of the photoreceptor, resulting in deterioration of image quality, and a tailing image problem in that images with a tail are produced. In addition, it is described in JP2006-071856A that a photoreceptor having a protective layer including an inorganic filler therein has high residual potential.

Therefore, there are proposals such that a protective layer having a dense three-dimensional crosslinked structure is formed by increasing the amount of a radically crosslinkable functional group in a crosslinking component without using an inorganic filler.

For example, there is a disclosure such that by using a monomer having an acrylic group and a low acrylic equivalence (i.e., a value obtained by dividing the molecular weight of a compound by the number of functional groups included therein), high abrasion resistance can be imparted to the resultant photoreceptor. However, when the number of functional groups is increased to increase the crosslinking points, the amount of an unreacted monomer and the amount of unreacted functional groups increase, thereby increasing the residual potential of the resultant photoreceptor.

In addition, there are proposals such that an outermost layer is formed using a radically polymerizable monomer having a specific structure such as bisphenol A to produce a molecule entanglement effect such that the molecules of the resultant polymer are entangled like entanglement of molecules of a linear polymer, thereby preventing cut molecules of the polymer, which are cut when the photoreceptor is charged or cleaned (i.e., when the polymer in the outermost layer is charged and heated in the charging process and the cleaning process), from being extracted from the outermost layer by the cleaning blade and the developer, resulting in reduction of abrasion loss.

Therefore, a need exits for a photoreceptor which has good abrasion resistance and which hardly increases residual potential even after long repeated use.

For these reasons, the inventors recognized that there is a need for a photoreceptor which has good durability and which can stably produce high quality images without increasing residual potential.

### BRIEF SUMMARY OF THE INVENTION

As an aspect of the present invention, a photoreceptor is provided which includes at least an electroconductive substrate, a photosensitive layer located overlying the electroconductive substrate, and an outermost layer located overlying the photosensitive layer. The outermost layer includes a crosslinked resin and a filler. The crosslinked resin includes at least a group derived from a polycarboxylic acid compound (i.e., a residual group of a polycarboxylic acid compound), and a group having the following formula (1):

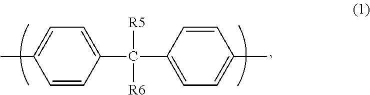

wherein each of R5 and R6 independently represents a hydrogen atom, or a substituted or unsubstituted alkyl group having 1 to 3 carbon atoms.

As another aspect of the present invention, an image forming apparatus is provided which includes the above-mentioned photoreceptor, an electrostatic latent image forming device to form an electrostatic latent image on a surface of the photoreceptor, a developing device to develop the electrostatic latent image with a developer including a toner to form a toner image on the surface of the photoreceptor, a transferring device to transfer the toner image onto a recording material, and a cleaner to clean the surface of the photoreceptor after the toner image is transferred. A combination of a charger to charge the surface of the photoreceptor, and an irradiator to irradiate the charged surface of the photoreceptor with light to form an electrostatic latent image on the surface of the photoreceptor is exemplified as the electrostatic latent image forming device.

As yet another aspect of the present invention, an image forming method is provided which includes forming an electrostatic latent image on a surface of the above-mentioned photoreceptor, developing the electrostatic latent image with a developer including a toner to form a toner image on the surface of the photoreceptor, transferring the toner image onto a recording material, and cleaning the surface of the photoreceptor after transferring the toner image.

As a further aspect of the present invention, a process cartridge is provided which includes the above-mentioned photoreceptor, and at least one of a charger to charge a surface of the photoreceptor, a developing device to develop an electrostatic latent image on the photoreceptor with a developer including a toner to form a toner image on the surface of the photoreceptor, a transferring device to transfer the toner image onto a recording material, and a cleaner to clean the surface of the photoreceptor after transferring the toner image. The photoreceptor and one or more of these devices are integrated into a single unit so as to be detachably attachable to an image forming apparatus.

As a still further aspect of the present invention, a coating liquid for forming an outermost layer of a photoreceptor is provided which includes at least a filler, a polycarboxylic acid compound, and a radically polymerizable monomer having the following formula (2):

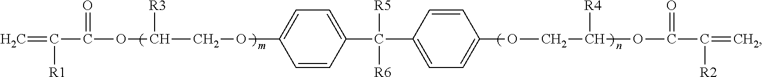

wherein each of R1 to R6 independently represents a hydrogen atom, or a substituted or unsubstituted alkyl group having 1 to 3 carbon atoms, and each of m and n is independently an integer of from 1 to 5.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIGS. 1A and 1B are schematic cross-sectional views illustrating examples of the photoreceptor of the present invention;

FIG. 2 is a schematic cross-sectional view illustrating an image forming section of an example of the image forming apparatus of the present invention; and

FIG. 3 is a schematic cross-sectional view illustrating an example of the process cartridge of the present invention.

### DETAILED DESCRIPTION OF THE INVENTION

Initially, the photoreceptor of the present invention will be described in detail.

The photoreceptor of the present invention includes at least an electroconductive substrate, a photosensitive layer located overlying the electroconductive substrate, and an outermost layer located overlying the photosensitive layer. The outermost layer includes a crosslinked resin and a filler. The crosslinked resin includes at least a group derived from a polycarboxylic acid compound (hereinafter referred to as a residual group of a polycarboxylic acid compound), and a group having the following formula (1):

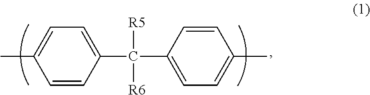

wherein each of R5 and R6 independently represents a hydrogen atom, or a substituted or unsubstituted alkyl group having 1 to 3 carbon atoms.

In this regard, “overlying” can include direct contact and allow for one or more intermediate layers.

The outermost layer is prepared by coating a coating liquid in which a filler is dispersed. In this regard, in order to stably disperse a filler in the coating liquid (i.e., to prevent a filler from precipitating in the coating liquid), it is preferable to always circulate the coating liquid.

However, even when always circulating a coating liquid including a filler, the dispersibility of the filler gradually deteriorates, and therefore aggregation of the filler is formed. Namely, it is difficult to stably disperse a filler in a coating liquid to an extent such that aggregation of the filler is not formed. When aggregated filler particles are formed in the coating liquid, a problem such that pipes of a coating device such as spray coating devices is clogged with the aggregated filler particles, thereby forming coating defects in the resultant layer is caused in the coating process.

In addition, even when an outermost layer is formed using a fresh coating liquid (i.e., a coating liquid which is just prepared), aggregation of filler particles is often caused in the coated liquid in a coating process or a crosslinking process, thereby increasing residual potential of the resultant photoreceptor.

The outermost layer coating liquid of the present invention includes at least a filler, a polycarboxylic acid compound, and a radically polymerizable monomer having the following formula (2):

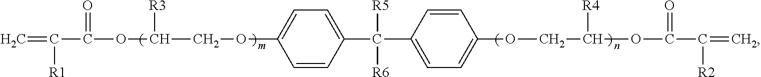

wherein each of R1 to R6 independently represents a hydrogen atom, or a substituted or unsubstituted alkyl group having 1 to 3 carbon atoms, and each of m and n is independently an integer of from 1 to 5.

The outermost layer coating liquid of the present invention has excellent filler dispersibility, and hardly causes the filler aggregation problem even when being used for a long period of time.

The reason why the outermost coating liquid of the present invention hardly causes the filler aggregation problem is not yet determined, but is considered to be that the polycarboxylic acid compound included in the coating liquid is adsorbed on the surface of the filler, thereby improving the affinity of the filler for the solvent included in the coating liquid, resulting in improvement of the dispersing stability of the filler in the coating liquid.

In addition, it is considered that since the bisphenol skeleton in the formula (1) is bulky, a steric hindrance effect is caused around the filler. In this case, since the polycarboxylic acid compound is adsorbed on the surface of the filler, the steric hindrance effect can be enhanced, thereby maintaining the intervals between filler particles, resulting in dramatic improvement of the dispersing stability of the filler. Therefore, an even outermost layer, which hardly includes aggregated filler particles, can be formed by the coating liquid.

Further, since the outermost layer coating liquid includes a filler, a polycarboxylic acid compound, and a radically polymerizable monomer including a bisphenol skeleton having formula (1), both the above-mentioned molecule entanglement effect and the filler dispersibility improving effect can be produced at the same time, and therefore an outermost layer having good abrasion resistance (i.e., high strength) while hardly increasing residual potential of the resultant photoreceptor can be prepared.

In this regard, whether an outermost layer of a photoreceptor includes a group having formula (1) can be determined by subjecting the outermost layer, which remains on the photoreceptor, or the outermost layer peeled from the photoreceptor to FT-IR or gas chromatograph mass spectrometry.

Next, the radically polymerizable monomer for use in the outermost layer coating liquid will be described.

The outermost layer (crosslinked resin layer) can be formed by coating the outermost layer coating liquid and applying an external energy thereto to crosslink the layer. The outermost layer coating liquid of the present invention includes a radically polymerizable difunctional monomer, which has the below-mentioned formula (2) and includes a group having formula (1) and an acryloyloxy group or a methacryloyloxy group.

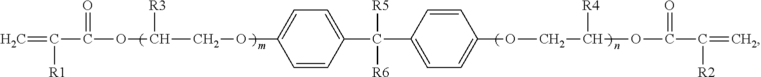

In formula (2), each of R1 to R6 independently represents a hydrogen atom, or a substituted or unsubstituted alkyl group having 1 to 3 carbon atoms, and each of m and n is independently an integer of from 1 to 5.

In formula (2), each of m and n is preferably an integer of from 1 to 5. When m or n is greater than 5, bulkiness of the monomer deteriorates, thereby lessening the filler dispersing stability improving effect.

The added amount of a radically polymerizable monomer having formula (2) is preferably not less than 3 parts by weight based on one part by weight of the filler included in the coating liquid. When the added amount is less than 3 parts by weight, the steric hindrance effect cannot be satisfactorily produced, and thereby the filler dispersing stability improving effect cannot be satisfactorily produced.

A radically polymerizable monomer having formula (2) can be used alone or in combination with another radically polymerizable monomer. Any known radically polymerizable compounds can be used as such radically polymerizable monomers, but radically polymerizable monomers having an acryloyloxy group or a methacryloyloxy group are preferable. Among such monomers having an acryloyloxy group or a methacryloyloxy group, radically polymerizable tri- or more-functional monomers or radically polymerizable compounds having a charge transport structure are more preferable.

Monomers having three or more acryloyloxy groups can be prepared by subjecting a compound having three or more hydroxyl groups to an ester reaction or an ester exchange reaction using acrylic acid (or salt), an acrylyl halide, or an acrylic ester. Monomers having three or more methacryloyloxy groups can be prepared by the similar method. The three or more polymerizable functional groups of such monomers may be the same as or different from each other.

Specific examples of the radically polymerizable tri- or more-functional monomers having three or more (meth)acryloyloxy groups include, but are not limited thereto, trimethylolpropane triacrylate (TMPTA), trimethylolpropane trimethacylate, trimethylolpropane alkylene-modified triacrylate, trimethylolpropane ethylene oxy (EO)-modified triacrylate, trimethylolpropane propyleneoxy (PO)-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin (ECH)-modified triacrylate, glycerol EO-modified triacrylate, glycerol PO-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol pentaacrylate, alkylated dipentaerythritol tetraacrylate, alkylated dipentaerythritol triacrylate, dimethylolpropane tetraacry late (DTMPTA), pentaerhythritol ethoxytetracrylate, EO-modified triacryl phosphate, and 2,2,5,5-tetrahydroxymethylcyclopentanone tetraacrylate. These compounds can be used alone or in combination.

When a radically polymerizable tri- or more-functional monomer is included in the outermost layer coating liquid, the resultant layer can have a well-developed three dimensional network, a high cross-linkage density, a high hardness, and a high elasticity, and a good combination of abrasion resistance and scratch resistance can be imparted to the photoreceptor.

Specific examples of the above-mentioned radically polymerizable compound having a charge transport structure include compounds which have a positive-hole transport structure (such as structures of triarylamine, hydrazone, pyrazoline, and carbazole), and/or an electron transport structure (such as structures of condensed polycyclic quinone, diphenoxyquinone, and electron accepting aromatic rings having a cyano group or a nitro group) and which have a radically polymerizable functional group (preferably acryloyloxy group or methacryloyloxy group).

When the outermost layer is formed by a coating liquid including a radically polymerizable compound having a charge transport structure, the resultant outermost layer has a charge transport function, and therefore the electric properties of the photoreceptor can be improved.

The number of functional groups of the radically polymerizable compound having a charge transport structure is not particularly limited, but monofunctional compounds are preferable because the resultant photoreceptor can have good electrostatic property stability and the resultant outermost layer has good property as a film. When a di- or more-functional compound is used, the cross-linkage density of the crosslinked network can be enhanced, but the resultant crosslinked layer has large distortion because the charge transport structure is very bulky, thereby increasing the internal stress of the layer. In addition, since the resultant layer cannot stably achieve an intermediate structure (i.e., a cation-radical state) in the charge transport process, charges are easily trapped, thereby deteriorating the photosensitivity of the photoreceptor and increasing residual potential of the photoreceptor.

Specific examples of the radically polymerizable compound having a charge transport structure include the compounds described in a U.S. Pat. No. 7,175,957 incorporated herein by reference.

It is preferable to use a radically polymerizable compound having a charge transport structure for the outermost layer to impart good charge transport property to the outermost layer. The content of a unit (group) obtained from a radically polymerizable compound having a charge transport structure in the outermost layer is determined depending on the image forming process of the image forming apparatus for which the photoreceptor is used, because the requirements (such as electric properties and abrasion resistance) for the photoreceptor change depending on the image forming process. However, the content is generally from 20% to 80% by weight, and preferably from 30% to 70% by weight, based on the total weight of the outermost layer. When the content is lower than 20% by weight, the outermost layer tends to have insufficient charge transportability, thereby deteriorating the electrostatic properties of the photoreceptor (e.g., deteriorating the photosensitivity of the photoreceptor, and increasing residual potential of the photoreceptor) when the photoreceptor is repeatedly used. In contrast, when the content is higher than 80% by weight, the content of the unit obtained from a radically polymerizable compound having no charge transport structure compound in the outermost layer decreases, thereby decreasing the three dimensional cross-linkage density of the outermost layer, resulting in deterioration of the abrasion resistance and scratch resistance of the outermost layer.

The unit obtained from a radically polymerizable compound having a charge transport structure in the outermost layer cannot be isolated because the outermost layer is crosslinked. However, by subjecting the outermost layer, which remains on the photoreceptor, or the outermost layer peeled from the photoreceptor to FT-IR or gas chromatograph mass spectrometry, the unit having a charge transport structure can be quantified. Therefore, the above-mentioned content (i.e., concentration ratio of the unit having a charge transport structure to the unit having no charge transport structure) can be determined.

Radically polymerizable mono- or di-functional monomers or oligomers can be used in combination with the radically polymerizable compounds mentioned above. Any known radically polymerizable mono- or di-functional monomers or oligomers can be used.

Specific examples of the radically polymerizable monofunctional monomers having no charge transport structure include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, and styrene.

Specific examples of the radically polymerizable difunctional monomers having no charge transport structure include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentylglycol diacrylate, bisphenol A—ethyleneoxy(EO)-modified diacrylate, bisphenol F—ethyleneoxy(EO)-modified diacrylate, and neopentylglycol diacrylate.

Specific examples of the functional monomers for use in imparting a special function (such as low surface energy and/or low friction coefficient) to the outermost layer include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates, and methacrylates, which are described in JP H05-60503A and JP H06-45770A and which have a siloxane group such as siloxane units having a repeat number of from 20 to 70 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

Specific examples of the radically polymerizable oligomers include epoxyacrylate oligomers, urethane acrylate oligomers, and polyester acrylate oligomers.

Next, the filler to be included in the outermost layer will be described.

The outermost layer coating liquid of the present invention includes a filler. By forming a crosslinked outermost layer including a filler, a good abrasion resistance can be imparted to the resultant photoreceptor.

One or more of inorganic fillers, organic fillers, and particulate carbons can be used as the filler. Among these fillers, inorganic fillers are preferable because of forming a stronger film.

Specific examples of inorganic fillers for use in the outermost layer include powders of metals such as copper, tin, aluminum and indium; powders of metal oxides such as silicon oxide (silica), tin oxide, zinc oxide, titanium oxide, alumina, indium oxide, antimony oxide, and bismuth oxide; and other inorganic materials such as potassium titanate. Among these inorganic fillers, metal oxide powders are preferable. In addition, colloidal silica and colloidal alumina can also be used preferably.

Specific examples of organic fillers for use in the outermost layer include powders of fluorine-containing resins such as polytetrafluoroethylene, powders of silicone resins, and particulate carbons (i.e., particulate materials including carbon as a main component). Specific examples of the particulate carbons include powders of carbons having a structure such as amorphous, diamond, graphite, fullerene, Zeppelin, carbon nanotube, and carbon nanohorn structures. Among these particulate carbons, diamond carbon or amorphous carbon, which includes hydrogen, is preferable because of having good mechanical and chemical durability. Hydrogen-containing diamond carbon or amorphous carbon is particulate carbon having a mixed structure of a diamond structure having a SP3 orbital, a graphite structure having a SP2 orbital, and an amorphous structure. Diamond carbon or amorphous carbon can include elements other than carbon, such as hydrogen, oxygen, nitrogen, fluorine, boron, phosphorous, chlorine, chlorine, bromine, and iodine.

When the concentration of a filler in the outermost layer is too high, problems such that residual potential of the photoreceptor increases, and optical transmittance of the outermost layer deteriorates tend to be caused. Therefore, the concentration of the filler in the outermost layer is generally from 1% to 30% by weight, and preferably from 1% to 20% by weight, based on the total weight of the outermost layer in order to balance the abrasion resistance and the properties (residual potential and optical transmittance) of the photoreceptor.

The average primary particle diameter of the filler included in the outermost layer is preferably from 0.1 μm to 1.0 μm, and more preferably from 0.1 μm to 0.5 μm. When the average primary particle diameter of the filler is smaller than 0.1 μm, the filler tends to easily aggregate in the outermost layer coating liquid, resulting in deterioration of the long-term stability of the coating liquid and the mechanical durability of the outermost layer. In contrast, when the average primary particle diameter is larger than 1.0 μm, the surface of the outermost layer is roughened (i.e., the outermost layer has large projections), and therefore the behavior of a cleaning blade contacted with the surface of the outermost layer becomes unstable, resulting in defective cleaning. In addition, the cleaning blade is easily damaged by the roughened outermost layer.

The particle diameter of particles of the filler dispersed in the outermost layer is preferably from 0.2 μm to 1.1 μm, and more preferably from 0.2 μm to 0.5 μm. In this regard, the particle diameter of filler particles dispersed in the outermost layer is the number average particle diameter. Specifically, the particle diameter of a filler in the outermost layer is determined by observing a cross-section of a cut photoreceptor, which includes the outermost layer including the filler, using an electron microscope.

Next, a dispersant will be described.

It is important that the surface of the filler to be included in the outermost layer is treated with a polycarboxylic acid compound to enhance the dispersing stability of the filler. In particular, the dispersing stability of such a surface treated filler can be dramatically improved by the interaction with the bisphenol skeleton represented by formula (1), thereby preventing the resultant photoreceptor from causing the residual potential increasing problem such that aggregated filler particles serve as charge traps, thereby increasing the residual potential of the resultant photoreceptor.

The polycarboxylic acid used for the outermost layer coating liquid is an unsaturated polycarboxylic acid, because the unsaturated polycarboxylic acid is reacted with a radically polymerizable monomer having formula (2) or a radically polymerizable monomer used for the outermost layer coating liquid, and thereby the polycarboxylic acid is fixed in the resultant resin, resulting in enhancement of the abrasion resistance of the outermost layer.

Suitable examples of the polycarboxylic acid include monomers including one or more of a carboxylic acid, a carboxylic acid salt, a carboxylic acid ester, and a carboxylic anhydride; and monomers in which one or more of the above-mentioned carboxylic acid compounds are reacted (connected) with another monomer.

Specific examples of the above-mentioned carboxylic acid compounds include monocarboxylic acids such as (meth)acrylic acid and crotonic acid; dicarboxylic acids; poly- (tri- or more-basic) carboxylic acids; and salts, esters and anhydrides thereof.

Any known monomers can be used as the monomer to be reacted with the above-mentioned carboxylic acid compounds as long as the resultant dispersant can be dissolved in the solvent used for forming the outermost layer coating liquid while having good compatibility with the radically polymerizable monomer used for the outermost layer coating liquid. Specific examples thereof include acrylonitrile, (meth)acrylamide, styrene, polyethylene (unsaturated), styrene sulfonic acid, methacryl sulfonic acid, and metal salts of styrene sulfonic acid, methacryl sulfonic acid.

Specific examples of the dibasic carboxylic acids mentioned above include aliphatic dicarboxylic acids having 2 to 20 carbon atoms such as maleic acid, fumaric acid, succinic acid, adipic acid, sebacic acid, malonic acid, azelaic acid, mesaconic acid, citraconic acid, and glutaconic acid; alicyclic dicarboxylic acids having 8 to 20 carbon atoms such as cyclohexane dicarboxylic acid, and methyl nadic acid; aromatic dicarboxylic acids having 8 to 20 carbon atoms such as phthalic acid, isophthalic acid, terephthalic acid, toluene dicarboxylic acid, and naphthalene dicarboxylic acid; alkyl or alkenyl succinic acids having 4 to 35 carbon atoms in their side chains such as isododecenyl succinic acid, and n-dodecenyl succinic acid; and anhydrides and lower alkyl (such as methyl and butyl)esters of the above-mentioned dicarboxylic acids.

Specific examples of the polycarboxylic acids include aliphatic polycarboxylic acids having 7 to 20 carbon atoms such as 1,2,4-butanetricarboxylic acid, 1,2,5-hexanetricarboxylic acid, 1,3-dicarboxyl-2-methyl-2-methylenecarboxy propane, tetra(methylenecarboxyl)methane, and 1,2,7,8-octanetetracarboxylic acid; alicyclic polycarboxylic acids having 9 to 20 carbon atoms such as 1,2,4-cyclohexanetricarboxylic acid; aromatic polycarboxylic acids having 9 to 20 carbon atoms such as 1,2,4-benzenetricarboxylic acid, 1,2,5-benzenetricarboxylic acid, 2,5,7-naphthalenetricarboxylic acid, 1,2,4-naphthalenetricarboxylic acid, pyromellitic acid, and benzophenonetetracarboxylic acid; and anhydrides and lower alkyl (such as methyl and butyl)esters of the above-mentioned polycarboxylic acids.

Specific examples of marketed products of these polycarboxylic acid compounds include BYK-P104, BYK-P105, and BYK-220S, which are from BYK Chemie AG, and HOMOGENOL L-18 from Kao Corp.

The polycarboxylic acid used for the outermost layer coating liquid preferably has an acid value of from 150 mgKOH/g to 500 mgKOH/g. When the acid value is less than 150 mgKOH/g, the dispersibility of the filler tends to deteriorate. In contrast, when the acid value is greater than 500 mgKOH/g, the residual potential of the resultant photoreceptor tends to increase.

The added amount of a polycarboxylic acid compound is determined depending on the average primary particle diameter of the filler used, but is generally from 0.1% to 50% by weight, and preferably from 10% to 30% by weight, based on the weight of the filler included in the outermost layer. When the added amount is less than 0.1% by weight, the filler dispersing effect cannot be satisfactorily produced. In contrast, when the added amount is greater than 50% by weight, the residual potential of the resultant photoreceptor tends to increase.

The reason why a filler can be well dispersed by such a dispersant is not yet determined, but is considered as follow. When a hydrophilic group such as carboxyl group is present in an organic molecular structure having hydrophobicity, the above-mentioned effect can be produced. Since polycarboxylic acids having many carboxyl groups have a higher anionic property, polycarboxylic acids have good wetting property and adsorbing property, and therefore the dispersibility of a filler can be enhanced. Namely, some of the carboxyl groups of a molecule of a carboxylic acid compound adsorb on a particle of a filler, and some of the carboxyl groups of the molecule repulse carboxyl groups of another molecule of the carboxylic acid compound adsorbing on another particle of the filler. Therefore, agglomeration of particles of the filler can be prevented three-dimensionally.

After the outermost layer is crosslinked, the polycarboxylic acid compound included in the crosslinked resin. In this regard, the unit obtained from (derived from) the polycarboxylic acid compound in the crosslinked resin is hereinafter referred to as a residual group.

Next, the filler dispersing method will be described.

Any known dispersing methods can be used for dispersing a filler such as fillers mentioned above. For example, methods in which a filler, a polycarboxylic acid compound, an organic solvent, and an optional dispersant, which is different from the polycarboxylic acid compound, are subjected to a dispersing treatment using a dispersing machine such as ball mills, attritors, sand mills, and supersonic dispersing machines can be used.

When a dispersing machine using a media is used, media such as zirconia, alumina and agate are preferably used. Among these media, alumina is preferable because a filler can be satisfactorily dispersed in a solvent, and the residual potential of the photoreceptor is hardly increased thereby. Further, α-alumina is more preferable because of having good abrasion resistance.

In this regard, whether the outermost layer of a photoreceptor includes a residual group of a polycarboxylic acid compound can be determined by subjecting the outermost layer, which remains on the photoreceptor, or the outermost layer peeled from the photoreceptor to FT-IR or gas chromatograph mass spectrometry.

The outermost layer of the photoreceptor of the present invention is typically prepared by coating an outermost layer coating liquid. In order to efficiently crosslink the outermost layer, a polymerization initiator can be added to the outermost layer coating liquid. Suitable polymerization initiators include heat polymerization initiators and photopolymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butyl peroxide, t-butylhydroperoxide, cumenehydroperoxide and lauroyl peroxide; and azo type initiators such as azobisisobutyronitrile, azobiscyclohexanecarbonitrile, azobisbutyric acid methyl ester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1-hydroxycyclohexyl phenyl ketone, 4-(2-hydroxyethoxy)phenyl(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acrylated benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, and imidazole compounds.

Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, and 4,4′-dimethylaminobenzophenone.

The added amount of such a polymerization initiator is preferably from 0.5 parts to 40 parts by weight, and more preferably from 1 part to 20 parts by weight, per 100 parts by weight of the total weight of the polymerizable compounds used for the outermost layer coating liquid.

The outermost layer coating liquid can optionally include other additives such as plasticizers (used for relaxing stress in the outermost layer, and improving the adhesiveness of the outermost layer with the photosensitive layer), leveling agents, compounds having an alkylamino group, antioxidants, and low molecular weight charge transport materials having no radical polymerizing ability.

Any known materials of these additives can be used for the outermost layer coating liquid.

Specific examples of the plasticizers include plasticizers for use in resins such as dibutyltin phthalate, and dioctyltin phthalate. The added amount of a plasticizer is generally not greater than 20% by weight, and preferably not greater than 10% by weight, based on the total weight of the solid components (including monomers and compounds used for forming the outermost layer) included in the outermost layer coating liquid.

Specific examples of the leveling agents include silicone oils (such as dimethylsilicone oils, and methylphenylsilicone oils), polymers and oligomers having a perfluoroalkyl group in their side chains. In addition, leveling agents having a polymerizable functional group can also be used. The added amount of a leveling agent is preferably not greater than 1% by weight based on the total weight of the solid components (including monomers and compounds used for forming the outermost layer) included in the outermost layer coating liquid.

Any known antioxidants such as phenolic compounds, paraphenylenediamine compounds, hydroquinone compounds, sulfur-containing organic compounds, phosphorous-containing organic compounds, and hindered amine compounds can be used for the outermost layer. By including an antioxidant in the outermost layer, good oxidation resistance can be imparted to the photoreceptor. However, addition of a large amount of antioxidant to the outermost layer often prevents crosslinking of the outermost layer, and/or increases residual potential of the resultant photoreceptor. Therefore, the added amount is preferably not greater than 3% by weight, and more preferably not greater than 2% by weight, based on the total weight of the solid components (including monomers and compounds used for forming the outermost layer) included in the outermost layer coating liquid.

The method for forming the outermost layer is not particularly limited. Specific examples thereof include a method including preparing an outermost layer coating liquid including a filler, a polycarboxylic acid compound, and a radically polymerizable monomer including a group having formula (1); and coating the coating liquid on the photosensitive layer (such as a single-layered photosensitive layer ad a charge transport layer), followed by crosslinking, resulting in preparation of the outermost layer. Since the polymerizable monomer is a liquid, other components can be dissolved or dispersed therein when preparing the outermost layer coating liquid. However, the outermost layer coating liquid can be optionally diluted by a solvent.

Specific examples of such a solvent include alcohols such as methanol, ethanol, propanol, and butanol; ketones such as acetone, methyl ethyl ketone, methyl isobutyl ketone, cyclopentanone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; and cellosolves such as methyl cellosolve, ethyl cellosolve, and cellosolve acetate. These solvents can be used alone or in combination. The added amount of a solvent is determined depending on the solubility of the components, coating methods, and the target thickness of the outermost layer.

The outermost layer is formed by coating the outermost layer coating liquid on the photosensitive layer, and then externally applying energy to the coated layer to crosslink the outermost layer. In this regard, suitable external energy includes heat energy, light energy, and radiation energy.

When heat crosslinking is performed, methods in which the coated layer and/or the substrate supporting the coated layer are heated using a heated gas (such as gasses (e.g., air, and nitrogen gas), and steam), a heating medium, infrared rays, or electromagnetic waves can be used. In this case, the temperature is preferably from 100° C. to 170° C. When the temperature is lower than 100° C., the reaction speed is slow, and the crosslinking reaction cannot be completely performed. In contrast, when the temperature is higher than 170° C., the crosslinking reaction unevenly proceeds, thereby causing problems in that a large strain is formed in the resultant crosslinked outermost layer; and a large number of unreacted groups remain (i.e., a large number of reaction terminals are formed) in the resultant outermost layer. In order to prepare an evenly crosslinked outermost layer, it is preferable to perform first heating at a relatively low temperature of lower than 100° C., followed by second heating at a relatively high temperature of not lower than 100° C. to complete the reaction.

When photo-crosslinking is performed, UV light sources such as high pressure mercury lamps, and metal halide lamps are preferably used. It is possible to use light sources emitting visible light when the polymerizable compounds and polymerization initiators can absorb visible light. The intensity of light is preferably not less than 50 mW/cm² and not greater than 1,000 mW/cm². When the intensity is less than 50 mW/cm², a long time is needed for performing the crosslinking reaction. When the intensity is greater than 1,000 mW/cm², the polymerization reaction is unevenly performed, thereby causing problems such that wrinkles are partially formed on the outermost layer; and a large number of unreacted groups remain (i.e., a large number of reaction terminals are formed) in the resultant outermost layer. In addition, since the resultant outermost layer has large internal stress due to rapid crosslinking reaction, problems such that cracks are formed in the outermost layer, and/or the outermost layer is peeled from the photosensitive layer are caused.

Specific examples of the radiation energy include electron beam energy.

Among these energies, heat energy or light energy are preferable because the reaction speed can be easily controlled, and simple energy application devices can be used.

The thickness of the outermost layer is preferably not less than 1.0 μm and not greater than 8.0 μm, and more preferably not less than 2.0 μm and not greater than 6.0 μm. When the outermost layer is too thick, the above-mentioned cracking and peeling problems, the residual potential increasing problem, and an uneven surface problem in that coating defects are formed and therefore the resultant outermost layer has an uneven surface, tend to be caused, thereby making it impossible to produce the effects of the present invention. In contrast, when the outermost layer is too thin, coating defects tend to be easily formed.

Next, the layer structure of the photoreceptor of the present invention will be described.

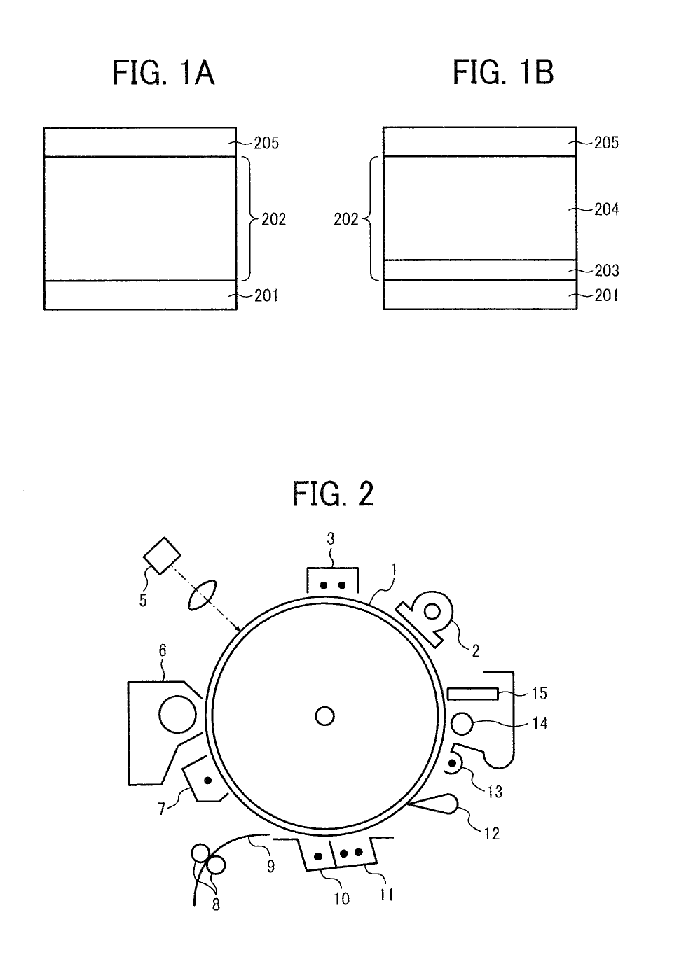

An example of the photoreceptor of the present invention is illustrated in FIG. 1A. The photoreceptor illustrated in FIG. 1A is a photoreceptor having a single-layered photosensitive layer, and includes an electroconductive substrate 201, a single-layered photosensitive layer 202 located on the electroconductive substrate 201, and an outermost layer 205, which is located on the photosensitive layer 202 and which is the outermost layer mentioned above.

Another example of the photoreceptor of the present invention is illustrated in FIG. 1B. The photoreceptor illustrated in FIG. 1B is a photoreceptor having a multi-layered photosensitive layer, and includes the electroconductive substrate 201, a multi-layered photosensitive layer 202 located on the electroconductive substrate 201 and including a charge generation layer 203 and a charge transport layer 204, and the outermost layer 205 located on the charge transport layer 204.

The structure of the photoreceptor of the present invention is not limited thereto. For example, an undercoat layer may be formed between the electroconductive substrate 201 and the photosensitive layer 202 to improve the charging property of the photoreceptor and to prevent occurrence of a background development problem in that background of images is soiled with toner particles. Such an undercoat layer may be formed of a single layer or multiple layers.

The electroconductive substrate 201 is not particularly limited as long as the substrate has a volume resistivity of not greater than 10¹⁰ Ω·cm. Specific examples of such materials include plastic cylinders, plastic films or paper sheets, on the surface of which a layer of a metal such as aluminum, nickel, chromium, nichrome, copper, gold, silver and platinum, or a layer of a metal oxide such as tin oxides and indium oxides, is formed by deposition or sputtering. In addition, a plate of a metal such as aluminum, aluminum alloys, nickel and stainless steel can be used. A metal cylinder, which is prepared by tubing a metal such as aluminum, aluminum alloys, nickel and stainless steel using a method such as impact ironing or direct ironing, and then subjecting the surface of the tube to one or more treatments such as cutting, super finishing and polishing, can also be used as the substrate. Further, endless nickel or stainless steel belts disclosed in published unexamined Japanese patent application No. 52-36016 can also be used as the electroconductive substrate 201.

Furthermore, substrates, in which a coating liquid including a binder resin and an electroconductive powder is coated on the supports mentioned above, can be used as the electroconductive substrate 201. Specific examples of such an electroconductive powder include carbon black, acetylene black, powders of metals such as aluminum, nickel, iron, nichrome, copper, zinc and silver, and powders of metal oxides such as electroconductive tin oxides and ITO. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins and alkyd resins.

Such an electroconductive layer can be formed by coating a coating liquid in which an electroconductive powder and a binder resin are dispersed or dissolved in a proper solvent such as tetrahydrofuran, dichloromethane, methyl ethyl ketone and toluene, and then drying the coated liquid.

In addition, substrates, in which an electroconductive resin film is formed on a surface of a cylindrical substrate using a heat-shrinkable resin tube which is made of a combination of a resin (such as polyvinyl chloride, polypropylene, polyesters, polyvinylidene chloride, polyethylene, chlorinated rubber and fluorine-containing resins (such as TEFLON)) and an electroconductive material, can also be used as the electroconductive substrate 201.

The photosensitive layer may be a single-layered photosensitive layer or a multi-layered photosensitive layer.

The multi-layered photosensitive layer typically includes a charge generation layer having a charge generating function, and a charge transport layer having a charge transport function. The single-layered photosensitive layer has both the charge generating function and the charge transport function.

Initially, the multi-layered photosensitive layer will be described.

The charge generation layer includes, as a main component, a charge generation material having a charge generating function, and optionally includes a binder resin. Known charge generation materials such as inorganic charge generation materials and organic charge generation materials can be used as the charge generation material. Specific examples of the inorganic charge generation materials include crystalline selenium, amorphous selenium, selenium-tellurium compounds, selenium-tellurium-halogen compounds, selenium-arsenic compound, and amorphous silicon. In addition, amorphous silicon in which a dangling bond is terminated with a hydrogen atom or a halogen atom or in which a boron atom, a phosphorous atom is doped can be preferably used.

Known organic charge generation materials can be used. Specific examples thereof include phthalocyanine pigments such as metal phthalocyanine and metal-free phthalocyanine; azulenium salt type pigments; squaric acid methyne pigments; azo pigments having a carbazole skeleton; azo pigments having a triphenyl amine skeleton; azo pigments having a diphenyl amine skeleton; azo pigments having a dibenzothiophene skeleton; azo pigments having a fluorenone skeleton; azo pigments having an oxadiazole skeleton; azo pigments having a bisstilbene skeleton; azo pigments having a distyryloxadiazole skeleton; azo pigments having a distyrylcarbazole skeleton; perylene pigments, anthraquinone pigments, polycyclic quinone pigments, quinone imine pigments, diphenylmethane pigments, triphenylmethane pigments, benzoquinone pigments, naphthoquinone pigments, cyanine pigments, azomethine pigments, indigoide pigments, and benzimidazole pigments. These are used alone or in combination.

Specific examples of the binder resins, which are optionally included in the charge generation layer, include polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, and polyacrylamide. These resins can be used alone or in combination. In addition, charge transport polymers having a charge transport function such as (1) polymers (e.g., polycarbonate, polyester, polyurethane, polyether, polysiloxane, and acrylic resins), which have an arylamine skeleton, a benzidine skeleton, a hydrazone skeleton, a carbazole skeleton, a stilbene skeleton, and/or a pyrazoline skeleton, and (2) polymers having a polysilane skeleton can also be used alone or in combination as the binder resin.

The charge generation layer can include a low molecular weight charge transport material such as positive-hole transport materials and electron transport materials. Any known low molecular weight charge transport materials can be used. Specific examples thereof include materials mentioned later for use in the charge transport layer.

The method for preparing the charge generation layer is not particularly limited, and a proper method is selected. For example, vacuum thin film forming methods, and casting methods using a solution/dispersion can be used. Specific examples of such vacuum thin film forming methods include vacuum evaporation methods, glow discharge decomposition methods, ion plating methods, sputtering methods, reaction sputtering methods, CVD (chemical vapor deposition) methods, and the like methods. A layer including one or more of the above-mentioned inorganic and organic materials can be formed by one of these methods.

The casting methods useful for forming the charge generation layer include, for example, the steps of preparing a coating liquid by dispersing (or dissolving) an inorganic or organic charge generation material in a solvent optionally together with a binder resin using a dispersing machine such as ball mills, attritors, sand mills, and bead mills; and coating the dispersion (or solution) after diluting the dispersion, if necessary, to prepare the charge generation layer. Specific examples of the solvent for use in the charge generation layer coating liquid include tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate, and butyl acetate.

The charge generation layer coating liquid can optionally include a leveling agent such as dimethylsilicone oils, and methylphenylsilicone oils. Specific examples of the coating methods include dip coating, spray coating, bead coating, and ring coating. The thickness of the charge generation layer is preferably from 0.01 μm to 5 μm, and more preferably from 0.05 μm to 2 μm.

The charge transport layer is a layer having a charge transport function, and is typically prepared by coating a coating liquid, which is prepared by dissolving or dispersing a charge transport material having a charge transport function and a binder resin in a solvent, on the charge generation layer, followed by drying the coated liquid. Specific examples of the charge transport materials include electron transport materials, positive hole transport materials, and polymeric charge transport materials. In addition, low molecular weight charge transport materials, which are broadly classified into electron transport materials, and positive hole transport materials, can also be used.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, and diphenoquinone derivatives. These electron transport materials can be used alone or in combination.

Specific examples of the positive hole transport materials include electron donating materials such as oxazole derivatives, oxadiazole derivatives, imidazole derivatives, monoarylamine derivatives, diarylamine derivatives, triphenylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, and enamine derivatives. These positive hole transport materials can be used alone or in combination.

Specific examples of the binder resin for use in the charge transport layer include known thermoplastic resins, and thermosetting resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonate, cellulose acetate resins, ethyl cellulose resins, polyvinyl butyral, polyvinyl formal, polyvinyl toluene, poly-N-vinyl carbazole, acrylic resins, silicone resins, epoxy resins, melamine resins, urethane resins, phenolic resins, and alkyd resins.

The content of a charge transport material is generally from 20 parts to 300 parts by weight, and preferably from 40 parts to 150 parts by weight, based on 100 parts by weight of the binder resin included in the charge transport layer. In this regard, a polymeric charge transport material can be used alone or in combination with a binder resin.

One or more of the solvents mentioned above for use in the charge generation layer coating liquid can also be used for the charge transport layer coating liquid. Among these solvents, solvents capable of well dissolving the binder resin, which is used for the charge transport layer, are preferable.

The charge transport layer can include additives such as plasticizers, leveling agents, antioxidants, light stabilizers, and ultraviolet absorbents. Specific examples of the plasticizers include plasticizers for use in resins such as dibutyltin phthalate, and dioctyltin phthalate. The added amount of a plasticizer is from 0 to 30 parts by weight based on 100 parts by weight of the binder resin included in the charge transport layer.

Specific examples of the leveling agents for use in the charge transport layer include silicone oils (such as dimethylsilicone oils, and methylphenylsilicone oils), and polymers and oligomers having a perfluoroalkyl group in their side chains. The added amount of a leveling agent is preferably from 0 to 1 part by weight based on 100 parts by weight of the binder resin included in the charge transport layer.

Any known antioxidants can be used for the charge transport layer. Specific examples thereof include phenolic compounds, paraphenylenediamine compounds, hydroquinone compounds, sulfur-containing organic compounds, phosphorous-containing organic compounds, and hindered amine compounds. By using an antioxidant, the electrostatic property of the photoreceptor can be stabilized even when the photoreceptor is repeatedly used for a long period of time.

The thickness of the charge transport layer is preferably from 5 μm to 40 μm, and more preferably from 10 μm to 30 μm. The charge transport layer can be prepared by the methods mentioned above for use in preparing the charge generation layer.

Next, a single-layered photosensitive layer will be described.

The single-layered photosensitive layer has both a charge generation function and a charge transport function, and is typically prepared by coating a coating liquid, which is prepared by dissolving or dispersing a charge generation material having a charge generation function, a charge transport material having a charge transport function, and a binder resin in a solvent, and then drying the coated liquid.

The single-layered photosensitive layer optionally includes additives such as plasticizers and leveling agents. The methods for dispersing a charge generation material, the charge generation materials, the charge transport materials, the plasticizers, and the leveling agents, which are mentioned above for use in preparing the charge generation layer and the charge transport layer, can be used for preparing the single-layered photosensitive layer.

The binder resins for use in the charge transport layer can be used for the single-layered photosensitive layer. In addition, the binder resins for use in the charge generation layer can be used in combination of the binder resins for use in the charge transport layer. Further, the polymeric charge transport materials mentioned above can also be used for the single-layered photosensitive layer. The thickness of the single-layered photosensitive layer is preferably from 5 μm to 30 μm, and more preferably from 10 μm to 25 μm. The methods mentioned above for use in preparing the charge generation layer can be used for preparing the single-layered photosensitive layer.

Next, the image forming method and apparatus of the present invention will be described by reference to drawings.

The image forming method and apparatus of the present invention use the above-mentioned photoreceptor of the present invention, and perform at least the following processes:
(1) an electrostatic latent image forming process in which the surface of the photoreceptor is charged and then irradiated with light to form an electrostatic latent image thereon;
(2) a developing process in which the electrostatic latent image is developed with a developer including a toner to form a toner image on the photoreceptor;
(3) a transferring process in which the toner image is transferred onto a recording material optionally via an intermediate transfer medium;
(4) a fixing process in which the toner image is fixed to the recording material; and
(5) a cleaning process in which the surface of the photoreceptor is cleaned after the toner image is transferred.

The image forming method is not limited thereto, and for example, a method in which an electrostatic latent image formed on the photoreceptor is directly transferred onto a recording material, and the electrostatic latent image is developed with a developer can also be used.

FIG. 2 illustrates an example of the image forming apparatus of the present invention. A charger 3 is used for uniformly charging a surface of a photoreceptor 1, which is the photoreceptor of the present invention.

Suitable devices for use as the charger 3 include known chargers capable of uniformly charging the photoreceptor, such as corotrons, scorotrons, solid state dischargers, needle electrodes, charging rollers, and electroconductive brush devices.

In this regard, contact and non-contact short-range chargers tend to easily cause a problem in that the components constituting the layers of a photoreceptor are decomposed by short-range discharging caused between the charger 3 and the photoreceptor. However, even when the photoreceptor of the present invention is charged by such a contact or non-contact short-range charger, the photoreceptor hardly causes the problem because of having such an outermost layer as mentioned above.

In this regard, the contact charging method is such that a charging member such as charging rollers, charging brushes, and charging blades is contacted with a surface of the photoreceptor 1 to charge the surface. In contrast, the short-range charging method is such that a charging member such as charging rollers is arranged in the vicinity of a surface of the photoreceptor 1 while forming a gap of not greater than 200 μm therebetween to charge the surface of the photoreceptor 1. When the gap is too wide, the photoreceptor is unstably charged. In contrast, when the gap is too narrow, it is possible that the charging member is contaminated with toner particles remaining on the surface of the photoreceptor. Therefore, the gap is preferably from 10 μm to 200 μm, and more preferably from 10 μm to 100 μm.

After the charger 3 charges a surface of the photoreceptor 1, an irradiator 5 irradiates the surface of the photoreceptor 1 with light to form an electrostatic latent image thereon. Suitable light sources for use in the irradiator 5 include fluorescent lamps, tungsten lamps, halogen lamps, mercury lamps, sodium lamps, light emitting diodes (LEDs), laser diodes (LDs), and light sources using electroluminescence (EL). In addition, in order to obtain light having a desired wave length range, filters such as sharp-cut filters, band pass filters, near-infrared cutting filters, dichroic filters, interference filters, and color temperature converting filters can be used for the irradiator 5.

In this image forming apparatus, the combination of the charger 3 and the irradiator 5 serves as an electrostatic latent image forming device.

Next, a developing device 6 develops the electrostatic latent image formed on the photoreceptor 1 with a developer including a toner to form a toner image on the photoreceptor 1. Suitable developing methods include dry developing methods (such as one component developing methods using a dry toner as a one-component developer, and two component developing methods using a two-component developer including a carrier and a dry toner), and wet developing methods using a wet toner.

When the photoreceptor 1, which is previously charged positively (or negatively), is exposed to light, an electrostatic latent image having a positive (or negative) charge is formed on the photoreceptor 1. When the electrostatic latent image having a positive (or negative) charge is developed with a toner having a negative (or positive) charge, a positive image can be obtained. In contrast, when the electrostatic latent image having a positive (negative) charge is developed with a toner having a positive (negative) charge, a negative image (i.e., a reversal image) can be obtained.

Next, a transfer charger 10 performs charging to transfer the toner image, which is formed on the photoreceptor 1 by the developing device 6, to a recording material 9, which is fed by a pair of registration rollers 8 to a transfer position. In order to satisfactorily perform the transfer operation, a pre-transfer charger 7 can be used. Suitable transfer methods include transfer methods using a transfer charger, electrostatic transfer methods using a bias roller, and mechanical transfer methods (such as transfer methods using an adhesive force or a pressure), and transfer methods using a magnetic force. The above-mentioned chargers for use as the charger 3 can be used for the electrostatic transfer methods.

The recording material 9, on which the toner image has been transferred, is separated from the photoreceptor 1 by a separation charger 11, and a separation pick 12. Other separation methods such as separation methods utilizing electrostatic attraction, separation methods using a belt end, separation methods including griping tip of a recording material, and separation methods utilizing curvature can also be used. The above-mentioned chargers for use as the charger 3 can be used for the separation charger 11.

When the toner image formed on the photoreceptor 1 by the developing device 6 is transferred onto the recording material 9, the entire toner image is not transferred onto the recording material 9, and toner particles remain on the surface of the photoreceptor 1. The residual toner particles are removed from the photoreceptor 1 by a fur brush 14 and a cleaning blade 15. In order to satisfactorily clean the surface of the photoreceptor 1, a pre-cleaning charger 13 can be used. Other cleaning methods such as web cleaning methods and magnet brush cleaning methods can also be used. These cleaning methods can be used alone or in combination.

If necessary, a discharger 2 performs a discharging operation to decay residual charges remaining on the surface of the photoreceptor after the cleaning operation. Suitable devices for use as the discharger 2 include discharging lamps and discharging chargers. The lamps mentioned above for use in the irradiator 5, and the chargers mentioned above for use in the charger 3 can be used for the discharger 2.

The image forming apparatus of the present invention can further include other devices such as a document reader to read the image of an original image with an image reader; a feeding device to feed the recording material 9 toward the photoreceptor 1; and a copy discharging device to discharge the recording material 9 bearing a fixed image thereon (i.e., a copy) from the image forming apparatus. Any known document readers, feeding devices, and copy discharging devices can be used for the image forming apparatus of the present invention. In addition, the image forming apparatus may include an intermediate transfer medium, which receives a toner image from the photoreceptor and transfers the toner image onto the recording material.

The image forming section illustrated in FIG. 2 can be fixedly set in an image forming apparatus such as copiers, facsimiles and printers. However, the image forming section can be detachably attached to an image forming apparatus as a process cartridge.

The process cartridge of the present invention includes the above-mentioned photoreceptor of the present invention, and at least one of a charger, an irradiator, a developing device, a transferring device, a cleaner, and a discharger, which are integrated into a single unit so as to be detachably attachable to an image forming apparatus.

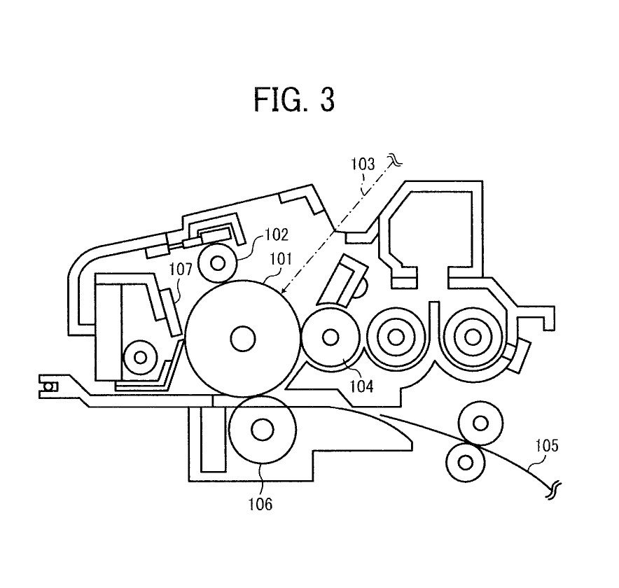

An example of the process cartridge is illustrated in FIG. 3. The process cartridge includes a photoreceptor 101, which is the photoreceptor of the present invention, a charger 102, a developing device 104, a transferring device 106, and a cleaner 107.

The process cartridge illustrated in FIG. 3 performs an image forming operation similar to the image forming operation mentioned above. Specifically, the photoreceptor 101 is rotated clockwise, and subjected to a charging process by the charger 102, followed by an irradiating process using light 103 emitted by an irradiator, thereby forming an electrostatic latent image on the surface of the photoreceptor 101. The electrostatic latent image is developed by the developing device 104 using a developer including a toner to form a toner image on the surface of the photoreceptor 101. The toner image is transferred onto a recording material 105 by the transferring device 106, and the recording material bearing the toner image thereon is discharged from the process cartridge. After the toner image is transferred, the surface of the photoreceptor 101 is cleaned by the cleaner 107. The photoreceptor 101 is optionally subjected to a discharging process to decay charges remaining on the surface thereof even after the transferring process.

The process cartridge of the present invention includes the photoreceptor having the above-mentioned outermost layer which has a smooth surface and a charge transport function, and at least one of a charger, a developing device, a transferring device, a cleaner, and a discharger.

The photoreceptor of the present invention can be used for electrophotographic image forming apparatuses such as electrophotographic copiers, laser beam printers, CRT printers, LED printers, LCD printers, and laser plate making apparatuses.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

The following components were fed into a 70 ml glass pot containing aluminum balls having a diameter of 5 mm.

| Alumina filler | 8 | parts |
|---|---|---|
| (SUMICORUNDUM AA-01 from Sumitomo | | |
| Chemical Co., Ltd., having an average primary | | |
| particle diameter of 0.1 μm) | | |
| Unsaturated polycarboxylic | 0.2 | parts |
| acid compound (dispersant) | | |
| (BYK-P105 from BYK Chemie Japan having | | |
| an acid value of 365 mgKOH/g) | | |
| Cyclopentanone | 8 | parts |
| Tetrahydrofuran | 12 | parts |

The glass pot was set on ball mill rotation shafts to be rotated for 24 hours at a revolution of 150 rpm to prepare a mill base.

Next, the following components were mixed to prepare an outermost layer coating liquid 1.

| Radically polymerizable compound having a charge transport structure and the following formula (A) | | 10 | parts |
|---|---|---|---|
| 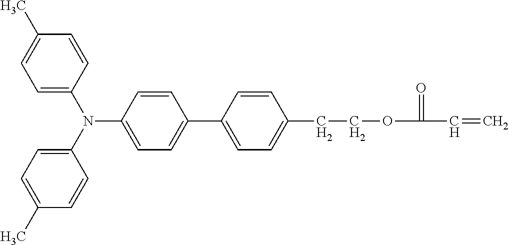 [SMILES: C=CC(=O)OCCc1ccc(-c2ccc(N(c3ccc(C)cc3)c3ccc(C)cc3)cc2)cc1] | (A) | | |
| Radically polymerizable monomer having the following formula (I) | | 10 | parts |
| 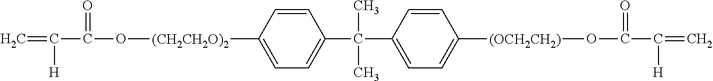 | (I) | | |

| | | |
|---|---|---|
| (SR349 from Sartomer) | | |
| Mill base prepared above | 3 | parts |
| Photopolymerization initiator | 1 | part |
| (1-hydroxycyclohexyl phenyl ketone, IRGACURE 184 from Ciba Specialty Chemicals) | | |
| Tetrahydrofuran | 120 | parts |

### Example 2

The procedure for preparation of the outermost layer coating liquid 1 in Example 1 was repeated except that the alumina filler was replaced with another alumina filler (SUMICORUNDUM AA-03 from Sumitomo Chemical Co., Ltd., having an average primary particle diameter of 0.3 μm) to prepare an outermost layer coating liquid 2.

### Comparative Example 1

The procedure for preparation of the outermost layer coating liquid 2 in Example 2 was repeated except that the dispersant was not used to prepare an outermost layer coating liquid 3.

### Example 3

The procedure for preparation of the outermost layer coating liquid 1 in Example 1 was repeated except that the alumina filler was replaced with a titanium oxide filler (CR-EL from Ishihara Sangyo Kaisha, having an average primary particle diameter of 0.25 μm) to prepare an outermost layer coating liquid 4.

### Example 4

The procedure for preparation of the outermost layer coating liquid 2 in Example 2 was repeated except that the filler was replaced with a particulate organic material (EPOSTAR S6 from Nippon Shokubai Co., Ltd., which is a melamine-formaldehyde condensate having an average primary particle diameter of from 0.3 μm to 0.6 μm), and the radically polymerizable monomer having formula (I) was replaced with a radically polymerizable monomer having the following formula (II):

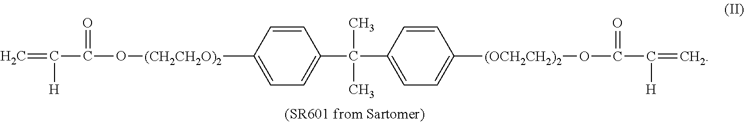

Thus, an outermost layer coating liquid 5 was prepared.

### Comparative Example 2

The procedure for preparation of the outermost layer coating liquid 5 in Example 5 was repeated except that the dispersant was replaced with dimethyldimethoxysilane (KBM-22 from Shin-Etsu Chemical Co., Ltd.) to prepare an outermost layer coating liquid 6.

### Example 5

The procedure for preparation of the outermost layer coating liquid 2 in Example 2 was repeated except that the dispersant was replaced with an unsaturated polycarboxylic acid compound (BYK-P104 from BYK Chemie having an acid value of 180 mgKOH/g), and the radically polymerizable monomer having formula (I) was replaced with a radically polymerizable monomer having the following formula (III):

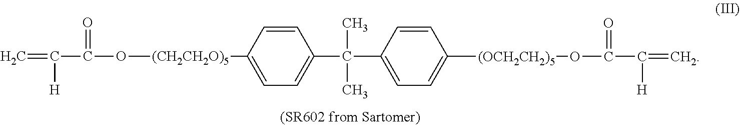

Thus, an outermost layer coating liquid 7 was prepared.

### Example 6

The procedure for preparation of the outermost layer coating liquid 7 in Example 5 was repeated except that the filler was replaced with another alumina filler (SUMICORUNDUM AA-10 from Sumitomo Chemical Co., Ltd., having an average primary particle diameter of 1.0 μm) to prepare an outermost layer coating liquid 8.

### Example 7

The procedure for preparation of the outermost layer coating liquid 2 in Example 2 was repeated except that the radically polymerizable monomer having formula (I) was replaced with a radically polymerizable monomer having the following formula (IV):

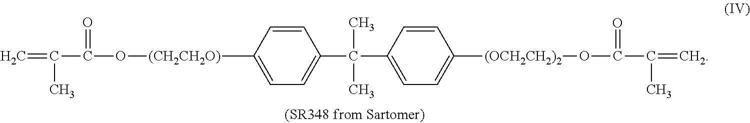

Thus, an outermost layer coating liquid 9 was prepared.

### Comparative Example 3

The procedure for preparation of the outermost layer coating liquid 9 in Example 7 was repeated except that the dispersant was not used to prepare an outermost layer coating liquid 10.

### Example 8

The procedure for preparation of the outermost layer coating liquid 2 in Example 2 was repeated except that the radically polymerizable monomer having formula (I) was replaced with a radically polymerizable monomer having the following formula (V):

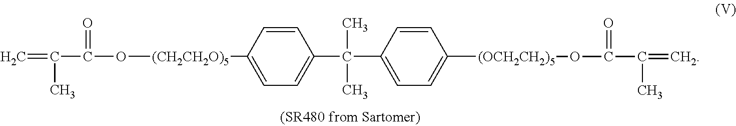

Thus, an outermost layer coating liquid 11 was prepared.

### Example 9

The procedure for preparation of the outermost layer coating liquid 2 in Example 2 was repeated except that the added amount of the radically polymerizable monomer having formula (I) was changed to 8 parts, and 2 parts of a radically polymerizable monomer having the following formula (VI) was added:

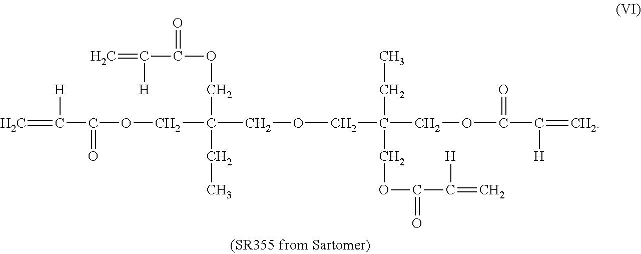 [SMILES: C=CC(=O)OCC(CC)(COCC(CC)(COC(=O)C=C)COC(=O)C=C)COC(=O)C=C]

Thus, an outermost layer coating liquid 12 was prepared.

### Example 10

The procedure for preparation of the outermost layer coating liquid 12 in Example 9 was repeated except that the added amount of the radically polymerizable monomer having formula (I) was changed to 7 parts, and the added amount of the radically polymerizable monomer having formula (VI) was changed to 3 parts to prepare an outermost layer coating liquid 13.

### Example 11

The procedure for preparation of the outermost layer coating liquid 2 in Example 2 was repeated except that the added amount of the radically polymerizable monomer having formula (I) was changed to 5 parts, and 5 parts of a monomer having the following formula (VII) was added:

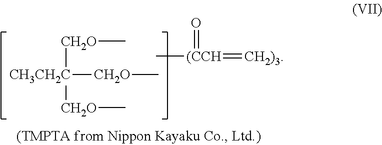

Thus, an outermost layer coating liquid 14 was prepared.

### Example 12

The procedure for preparation of the outermost layer coating liquid 2 in Example 2 was repeated except that the added amount of the radically polymerizable monomer having formula (I) was changed to 5 parts, and 3 parts of the radically polymerizable monomer having formula (VII) (i.e., KAYARAD TMPTA) and 2 parts of a radically polymerizable monomer having the following formula (VIII) were added:

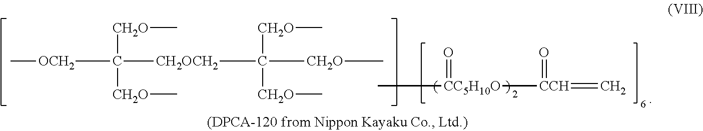

Thus, an outermost layer coating liquid 15 was prepared.

### Example 13

The procedure for preparation of the outermost layer coating liquid 15 in Example 12 was repeated except that the radically polymerizable monomer having formula (I) was replaced with the radically polymerizable monomer having formula (II) (i.e., SR601 from Sartomer), and the dispersant was replaced with the unsaturated polycarboxylic acid compound (BYK-P104 from BYK Chemie having an acid value of 180 mgKOH/g) to prepare an outermost layer coating liquid 16.

### Example 14

The procedure for preparation of the outermost layer coating liquid 16 in Example 13 was repeated except that the filler was replaced with the titanium oxide filler (CR-EL from Ishihara Sangyo Kaisha, having an average primary particle diameter of 0.25 μm) to prepare an outermost layer coating liquid 17.

### Comparative Example 4

The procedure for preparation of the outermost layer coating liquid 1 in Example 1 was repeated except that the radically polymerizable monomer having formula (I) was replaced with the radically polymerizable monomer having formula (VII) (i.e., KAYARAD TMPTA) to prepare an outermost layer coating liquid 18.

### Comparative Example 5

The procedure for preparation of the outermost layer coating liquid 2 in Example 2 was repeated except that the radically polymerizable monomer having formula (I) was replaced with the radically polymerizable monomer having formula (VII) (i.e., KAYARAD TMPTA) to prepare an outermost layer coating liquid 19.

### Comparative Example 6

The procedure for preparation of the outermost layer coating liquid 19 in Comparative Example 5 was repeated except that the dispersant was not used to prepare an outermost layer coating liquid 20.

### Comparative Example 7

The procedure for preparation of the outermost layer coating liquid 4 in Example 3 was repeated except that the radically polymerizable monomer having formula (I) was replaced with the radically polymerizable monomer having formula (VII) (i.e., KAYARAD TMPTA) to prepare an outermost layer coating liquid 21.

### Comparative Example 8

The procedure for preparation of the outermost layer coating liquid 6 in Comparative Example 2 was repeated except that the radically polymerizable monomer having formula (I) was replaced with the radically polymerizable monomer having formula (VII) (i.e., KAYARAD TMPTA) to prepare an outermost layer coating liquid 22.

### Comparative Example 9

The procedure for preparation of the outermost layer coating liquid 2 in Example 2 was repeated except that the radically polymerizable monomer having formula (I) was replaced with the radically polymerizable monomer having formula (VIII) (i.e., KAYARAD DPCA-120) to prepare an outermost layer coating liquid 23.

### Comparative Example 10

The procedure for preparation of the outermost layer coating liquid 2 in Example 2 was repeated except that the radically polymerizable monomer having formula (I) was replaced with the radically polymerizable monomer having formula (VI) (i.e., SR355) to prepare an outermost layer coating liquid 24.

### Comparative Example 11

The procedure for preparation of the outermost layer coating liquid 2 in Example 2 was repeated except that the radically polymerizable monomer having formula (I) was replaced with 5 parts of the radically polymerizable monomer having formula (VII) (i.e., KAYARAD TMPTA) and 5 parts of the radically polymerizable monomer having formula (VIII) (i.e., KAYARAD DPCA-120) to prepare an outermost layer coating liquid 25.

### Comparative Example 12

The procedure for preparation of the outermost layer coating liquid 4 in Example 3 was repeated except that the radically polymerizable monomer having formula (I) was replaced with 5 parts of the radically polymerizable monomer having formula (VII) (i.e., KAYARAD TMPTA) and 5 parts of the radically polymerizable monomer having formula (VIII) (i.e., KAYARAD DPCA-120) to prepare an outermost layer coating liquid 26.

### Example 15

The procedure for preparation of the outermost layer coating liquid 2 in Example 2 was repeated except that the radically polymerizable compound having formula (A) was not added and the added amount of the radically polymerizable monomer having formula (I) was changed to 20 parts to prepare an outermost layer coating liquid 27.

The thus prepared outermost layer coating liquids 1-27 were subjected to a circulation test, which is as follows.

Specifically, each coating liquid was circulated for 7 days using a TEFLON magnet pump (IPF-611 from AS ONE Corp.). In this regard, the average particle diameter of the filler of the coating liquid was measured before and after the test, and after the circulation was performed for 3 days using a particle diameter distribution analyzer from Horiba, Ltd., which uses photo-sedimentation with gravitational and centrifugal acceleration.

The results are shown in Table 1.

TABLE 1

| | | Average particle diameter (μm) | | |
|---|---|---|---|---|
| | | | After | After the test |
| | | | circulation | (after |
| | Number of the | | for | circulation for |
| | coating liquid | Before the test | three days | seven days) |
| Ex. 1 | 1 | 0.23 | 0.21 | 0.24 |
| Ex. 2 | 2 | 0.41 | 0.40 | 0.40 |
| Ex. 3 | 4 | 0.34 | 0.35 | 0.33 |
| Ex. 4 | 5 | 0.61 | 0.71 | 0.74 |
| Ex. 5 | 7 | 0.39 | 0.38 | 0.41 |
| Ex. 6 | 8 | 1.12 | 1.06 | 1.03 |
| Ex. 7 | 9 | 0.34 | 0.36 | 0.42 |
| Ex. 8 | 11 | 0.41 | 0.35 | 0.37 |
| Ex. 9 | 12 | 0.44 | 0.41 | 0.47 |
| Ex. 10 | 13 | 0.44 | 0.47 | 0.51 |
| Ex. 11 | 14 | 0.43 | 0.46 | 0.43 |
| Ex. 12 | 15 | 0.38 | 0.41 | 0.46 |
| Ex. 13 | 16 | 0.38 | 0.37 | 0.40 |
| Ex. 14 | 17 | 0.36 | 0.36 | 0.34 |
| Ex. 15 | 27 | 0.45 | 0.45 | 0.43 |
| Comp. Ex. 1 | 3 | 0.53 | 1.48 | 1.64 |
| Comp. Ex. 2 | 6 | 0.63 | 1.49 | 1.54 |
| Comp. Ex. 3 | 10 | 0.67 | 1.34 | 1.35 |
| Comp. Ex. 4 | 18 | 0.21 | 0.31 | 0.94 |
| Comp. Ex. 5 | 19 | 0.39 | 0.43 | 1.08 |
| Comp. Ex. 6 | 20 | 0.64 | 1.54 | 1.43 |
| Comp. Ex. 7 | 21 | 0.35 | 0.47 | 1.38 |
| Comp. Ex. 8 | 22 | 1.21 | 1.38 | 2.69 |
| Comp. Ex. 9 | 23 | 0.39 | 0.42 | 1.34 |
| Comp. Ex. 10 | 24 | 0.43 | 0.51 | 1.58 |
| Comp. Ex. 11 | 25 | 0.45 | 0.52 | 0.98 |
| Comp. Ex. 12 | 26 | 0.33 | 0.43 | 1.10 |

It is clear from Table 1 that since the average particle diameter of the filler in each of the outermost layer coating liquids of Examples 1-15, which includes a radically polymerizable monomer including a group having formula (1) and a polycarboxylic acid compound, hardly changed even after the circulation test was performed for 7 days, the filler was well dispersed in each coating liquid.

In contrast, in the coating liquids of Comparative Examples 1-3, each of which includes no polycarboxylic acid compound, and the coating liquids of Comparative Examples 4-12, each of which does not include a radically polymerizable monomer including a group having formula (1), the average particle diameter of the filler increased after the circulation test was performed for 3 days and 7 days. Namely, it was confirmed that the filler aggregated in the coating liquids.

Thus, it was confirmed that the outermost layer coating liquids of the present invention have good dispersing stability.

### Example 16

### Preparation of Undercoat Layer

The following components were mixed and subjected to a dispersing treatment to prepare an undercoat layer coating liquid.

| Titanium oxide A | 70 parts |
|---|---|
| (CR-EL from Ishihara Sangyo Kaisha) | |
| Titanium oxide B | 20 parts |
| (PT-401M from Ishihara Sangyo Kaisha) | |
| Alkyd resin | 14 parts |
| (BECKOLITE M6401-50 from DIC Corp., solid | |
| content of 50% by weight) | |
| Melamine resin | 8 parts |
| (L-145-60 from DIC Corp., solid | |
| content of 60% by weight) | |
| 2-Butanone | 70 parts |

The undercoat layer coating liquid was coated on an aluminum cylinder having an outer diameter of 40 mm by dip coating, and followed by drying in an oven to prepare an undercoat layer having a thickness of 3.0 μm.

### (Preparation of Charge Generation Layer)

The following components were mixed to prepare a polyvinyl butyral solution.

| Polyvinyl butyral | 4 | parts |
|---|---|---|
| (BX-1 from Sekisui Chemical Co., Ltd.) | | |
| 2-Butanone | 400 | parts |

The following components were mixed.

| Titanylphthalocyanine having the following formula (B) | | 8 | parts |
|---|---|---|---|
| 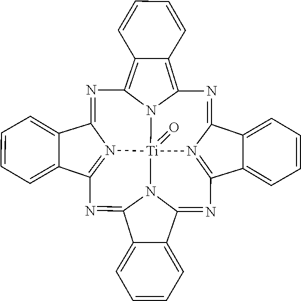 | (B) | | |

| | | |
|---|---|---|
| Polyvinylbutyral solution prepared above | 404 | parts |

The mixture was subjected to a dispersing treatment for 30 minutes using a bead mill, which contained PSZ balls having a diameter of 0.5 mm and whose rotor was rotated at a revolution of 1,200 rpm to prepare a charge generation layer coating liquid.

The charge generation layer coating liquid was coated on the undercoat layer by dip coating, followed by drying in an oven to prepare a charge generation layer having a thickness of 0.2 μm.

### (Preparation of Charge Transport Layer)

The following components were mixed to prepare a charge transport layer coating liquid.

| Bisphenol A-based polycarbonate | | 10 | parts |
|---|---|---|---|
| (PANLITE TS-2050 from Teijin Chemicals Ltd.) | | | |
| Charge transport material having the following formula (C) | | 10 | parts |
| 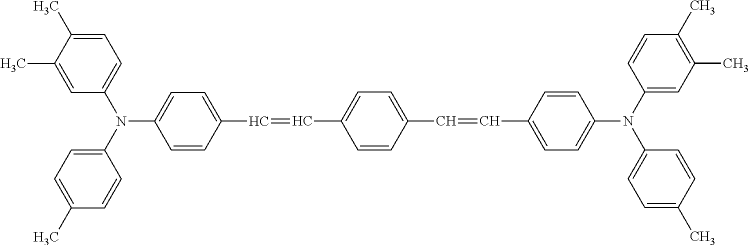 | (C) | | |

| | | |
|---|---|---|
| Tetrahydrofuran | 80 | parts |
| 1% Tetrahydrofuran solution of silicone oil | 0.2 | parts |
| (Silicone oil: KF50-100CS from Shin-Etsu Chemical Co., Ltd.) | | |

The charge transport layer coating liquid was coated on the charge generation layer, followed by drying in an oven to prepare a charge transport layer having a thickness of 23 μm.

### (Preparation of Outermost Layer)

The outermost layer coating liquid 2, which was just prepared, was coated on the charge transport layer by spray coating. The coated layer was irradiated with ultraviolet rays at an energy of 600 mW/cm², which were emitted by an UV irradiator from Fusion UV Systems, followed by drying for 20 minutes at 130° C. to prepare a photoreceptor having a crosslinked outermost layer having a thickness of 5 μm.

Similarly, a photoreceptor having a crosslinked outermost layer was prepared using the outermost layer coating liquid 2, which had been subjected to the circulation test for 7 days.

Thus, two photoreceptors of Example 16 were prepared.

### Example 17

The procedure for preparation of the photoreceptors in Example 16 was repeated except that the outermost layer coating liquid 2 was replaced with the outermost layer coating liquid 9 to prepare photoreceptors of Example 17.

### Example 18

The procedure for preparation of the photoreceptors in Example 16 was repeated except that the outermost layer coating liquid 2 was replaced with the outermost layer coating liquid 12 to prepare photoreceptors of Example 17.

### Example 19

The procedure for preparation of the photoreceptors in Example 16 was repeated except that the outermost layer coating liquid 2 was replaced with the outermost layer coating liquid 16 to prepare photoreceptors of Example 17.

### Example 20

The procedure for preparation of the photoreceptors in Example 16 was repeated except that the outermost layer coating liquid 2 was replaced with the outermost layer coating liquid 27 and the thickness of the crosslinked outermost layer was changed to 2 μm to prepare photoreceptors of Example 17.

### Comparative Example 13

The procedure for preparation of the photoreceptors in Example 16 was repeated except that the outermost layer coating liquid 2 was replaced with the outermost layer coating liquid 3 to prepare photoreceptors of Comparative Example 13.

### Comparative Example 14

The procedure for preparation of the photoreceptors in Example 16 was repeated except that the outermost layer coating liquid 2 was replaced with the outermost layer coating liquid 6 to prepare photoreceptors of Comparative Example 14.

### Comparative Example 15

The procedure for preparation of the photoreceptors in Example 16 was repeated except that the outermost layer coating liquid 2 was replaced with the outermost layer coating liquid 10 to prepare photoreceptors of Comparative Example 15.

### Comparative Example 16

The procedure for preparation of the photoreceptors in Example 16 was repeated except that the outermost layer coating liquid 2 was replaced with the outermost layer coating liquid 19 to prepare photoreceptors of Comparative Example 16.

### Comparative Example 17

The procedure for preparation of the photoreceptors in Example 16 was repeated except that the outermost layer coating liquid 2 was replaced with the outermost layer coating liquid 21 to prepare photoreceptors of Comparative Example 17.

### Comparative Example 18

The procedure for preparation of the photoreceptors in Example 16 was repeated except that the outermost layer coating liquid 2 was replaced with the outermost layer coating liquid 25 to prepare photoreceptors of Comparative Example 17.

The thus prepared photoreceptors of Examples 16-20 and comparative photoreceptors of Comparative Examples 13-18 were subjected to a running test, which is as follows.

Specifically, each photoreceptor was set in a process cartridge, and the process cartridge was set in a tandem digital color copier IMAGIO MPC5000 from Ricoh Co., Ltd., which includes a charger, an irradiator, a developing device, a transferring device, a fixing device, a cleaner, a lubricant applicator, and a discharger. In the running test, 10,000 copies of an A-4 size full color original image having an image area proportion of 5% were produced under normal temperature and humidity conditions (23° C. and 55% RH). Before and after the running test, the residual potential of the photoreceptor was measured by a method, in which an electrostatic latent image having an image area proportion of 100% (corresponding to a solid image) is formed on the photoreceptor, and the potential (in units of volt) of the electrostatic latent image (i.e., the potential of an irradiated portion of the photoreceptor, or residual potential) is measured with a potential sensor MODEL 344 from TREK Inc.

The results are shown in Table 2.

TABLE 2

| | | Potential of irradiated portion | | | |
|---|---|---|---|---|---|
| | | (residual potential) (−V) | | | |
| | | Before the running test | | After the running test | |
| | | Photo- | Photo- | Photo- | Photo- |
| | | receptor | receptor | receptor | receptor |
| | | prepared | prepared | prepared | prepared |
| | Number | by | by | by | by |
| | of | using | using | using | using |
| | outer- | coating | coating | coating | coating |
| | most | liquid | liquid | liquid | liquid |
| | layer | before | after | before | after |
| | coating | circulation | circulation | circulation | circulation |
| | liquid | test | test | test | test |
| Ex. 16 | 2 | 95 | 95 | 100 | 100 |
| Ex. 17 | 9 | 110 | 115 | 105 | 110 |
| Ex. 18 | 12 | 105 | 100 | 110 | 105 |
| Ex. 19 | 16 | 90 | 95 | 90 | 95 |
| Ex. 20 | 27 | 140 | 145 | 165 | 170 |
| Comp. | 3 | 125 | 165 | 150 | 265 |
| Ex. 13 | | | | | |
| Comp. | 6 | 130 | 170 | 165 | 260 |
| Ex. 14 | | | | | |
| Comp. | 10 | 145 | 190 | 220 | 340 |
| Ex. 15 | | | | | |
| Comp. | 19 | 95 | 130 | 95 | 200 |
| Ex. 16 | | | | | |
| Comp. | 21 | 105 | 140 | 110 | 210 |
| Ex. 17 | | | | | |
| Comp. | 25 | 110 | 140 | 110 | 230 |
| Ex. 18 | | | | | |

it is clear from Table 2 that the residual potentials of the photoreceptors of Examples 16-20, which were prepared using the outermost layer coating liquids of the present invention, were stable in the running test even when the outermost layers were formed using circulated outermost layer coating liquids. In contrast, the comparative photoreceptors of Comparative Examples 13-18 had higher residual potentials when the outermost layers were formed using circulated outermost layer coating liquids, and particularly the residual potentials of the comparative photoreceptors were higher after the running test than those before the running test.

Additional modifications and variations of the present invention are possible in light of the above teachings. It is therefore to be understood that within the scope of the appended claims the invention may be practiced other than as specifically described herein.

What is claimed is:

1. An electrophotographic photoreceptor comprising:
an electroconductive substrate;
a photosensitive layer located overlying the electroconductive substrate; and
an outermost layer located overlying the photosensitive layer, wherein the outermost layer includes a filler and a crosslinked resin having a residual group of a polycarboxylic acid compound and a group having the following formula (1): 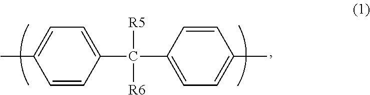
wherein each of R5 and R6 independently represents a hydrogen atom, or a substituted or unsubstituted alkyl group having 1 to 3 carbon atoms.

2. The photoreceptor according to claim 1, wherein the filler includes a particulate metal oxide.

3. The photoreceptor according to claim 1, wherein the crosslinked resin further includes a residual group of a radically polymerizable compound having a charge transport structure.

4. The photoreceptor according to claim 1, wherein the crosslinked resin further includes a residual group of a radically polymerizable polyfunctional monomer, and wherein the crosslinked resin is crosslinked using energy selected from the group consisting of heat energy, light energy, and radiation energy.

5. An image forming apparatus comprising:
the photoreceptor according to claim 1;
an electrostatic latent image forming device to form an electrostatic latent image on a surface of the photoreceptor;
a developing device to develop the electrostatic latent image with a developer including a toner to form a toner image on the surface of the photoreceptor;
a transferring device to transfer the toner image onto a recoding material; and
a cleaner to clean the surface of the photoreceptor after the toner image is transferred.

6. An image forming method comprising:
forming an electrostatic latent image on a surface of the photoreceptor according to claim 1;
developing the electrostatic latent image with a developer including a toner to form a toner image on the surface of the photoreceptor;
transferring the toner image onto a recording material; and
cleaning the surface of the photoreceptor after transferring the toner image.

7. A process cartridge comprising:
the photoreceptor according to claim 1; and
at least one of a charger to charge a surface of the photoreceptor, an irradiator to irradiate the charged photoreceptor, a developing device to develop an electrostatic latent image on the surface of the photoreceptor with a developer including a toner to form a toner image on the surface of the photoreceptor, a transferring device to transfer the toner image onto a recording material, and a cleaner to clean the surface of the photoreceptor after the toner image is transferred,
wherein the process cartridge is a single unit so as to be detachably attachable to an image forming apparatus.

8. A coating liquid for forming an outermost layer of a photoreceptor, comprising:
a filler;
a polycarboxylic acid compound; and
a radically polymerizable monomer having the following formula (2): 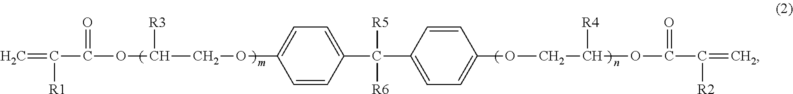
wherein each of R1 to R6 independently represents a hydrogen atom, or a substituted or unsubstituted alkyl group having 1 to 3 carbon atoms, and each of m and n is independently an integer of from 1 to 5.
